(19) United States
(12) Patent Application Publication
(10) Pub. No.: US 2014/0092429 A1
(43) Pub. Date: Apr. 3, 2014

(54) Associate a Document with a Printer

(71) Applicants: Venugopal K. Srinivasmurthy, Bangalore (IN); Ramesh Kavanappillil, Banglore (IN)

(72) Inventors: Venugopal K. Srinivasmurthy, Bangalore (IN); Ramesh Kavanappillil, Banglore (IN)

(21) Appl. No.: 13/989,787

(22) PCT Filed: May 31, 2011
(86) PCT No.: PCT/US11/38491

§ 371 Date: May 25, 2013

(51) Int. Cl. G06F 3/12

(52) U.S. Cl. CPC G06F 3/126
USPC 358/1.15

(57) ABSTRACT

Implementations disclosed herein relate to associating a document with a printer. In one embodiment, a subset of printers 111, 112, 113 is determined based on the location of the printers and a document is transmitted to one of the printers in the subset. In one embodiment, a document is transmitted to an electronic device that requested a print job for the document. In one embodiment, a processor 902 causes a selected document to be printed.

### BACKGROUND

A user may print a document by adding a printer to an electronic device, such as a printing with a printer communicating directly with the electronic device or communicating via a network. In some cases, a document may be transmitted or transported to another printer. For example, a document may be stored on a portable storage device that is then plugged into a different electronic device attached to a printer. As another example, a printer may communicate with an electronic device over a wireless network.

### BRIEF DESCRIPTION OF THE DRAWINGS

The drawings describe example implementations. The drawings show methods performed in an example order, but the methods may also be performed in other orders. The following detailed description references the drawings, wherein:

FIG. 1 is a block diagram illustrating one example of a computing system.

FIG. 2 is a flow chart illustrating one example of a method to associate a document with a printer based on the location of the printer.

FIG. 3A is a diagram illustrating one example of comparing printer locations to a preferred location.

FIG. 3B is a diagram illustrating one example of a user interface for selecting a printer.

FIG. 4 is a flow chart illustrating one example of associating a document with a printer based on the location of the printer.

FIG. 5 is a block diagram illustrating one example of a computing system.

FIG. 6 is a flow chart illustrating one example of a method to associate a document with a printer based on a request to print the document.

FIG. 7 is a flow chart illustrating one example of associating a document with a printer based on a request to print the document.

FIGS. 8A and 88 are flow charts and illustrating examples of methods and to transmit a document to a first printer for formatting and to a second printer for printing.

FIG. 9 is a block diagram illustrating one example of a computing system.

FIG. 10 is a flow chart illustrating one example of a method to select a document for printing.

### DETAILED DESCRIPTION

In some cases, an electronic device user may want to print a document where the user does not have access to a printer. For example, a user interface may allow a user to upload a document for printing and associate the document with a particular remote printer. In some cases, a user may want to locate nearby print services for printing the uploaded document. For example, an electronic device associated with the remote storage may compare the location of a printing service to a preferred location, such as the user's current location or a location specified by the user. The electronic device may provide the available printing services and location information related to each of them to the user to allow the user to select a printer or may automatically select one of the printing services based on their locations. For example, a printing service may be selected based on its convenience to the user for picking up the printed document. The electronic device may then send the document to the selected printing service.

In one implementation, a user may upload a document to a remote storage, and an electronic device associated with the remote storage may advertise via a network the available print job for the document. Electronic devices associated with printing services may request the print job. The printing service may, for example, request print jobs for delivery near the printing service. A user interface may present a user with his choices, or the computing system may automatically assign a print job to a requesting printing service. Such an implementation may be used, for example, where a printing service delivers printed documents to a user.

In some cases, a printer may retrieve documents for printing at the printer from a remote storage where the documents are associated with different user virtual printer accounts. For example, multiple users may upload documents for printing and select the printer based on its location or may receive a request from the printer to print the document. Because the printer may not be owned by the users, it may be useful to have a method of spam control to prevent ink waste caused by a printer automatically printing documents from users without the print owner's consent. For example, a printer may display documents for print and wait to print the documents until a user selects them or otherwise indicates that the printer may print.

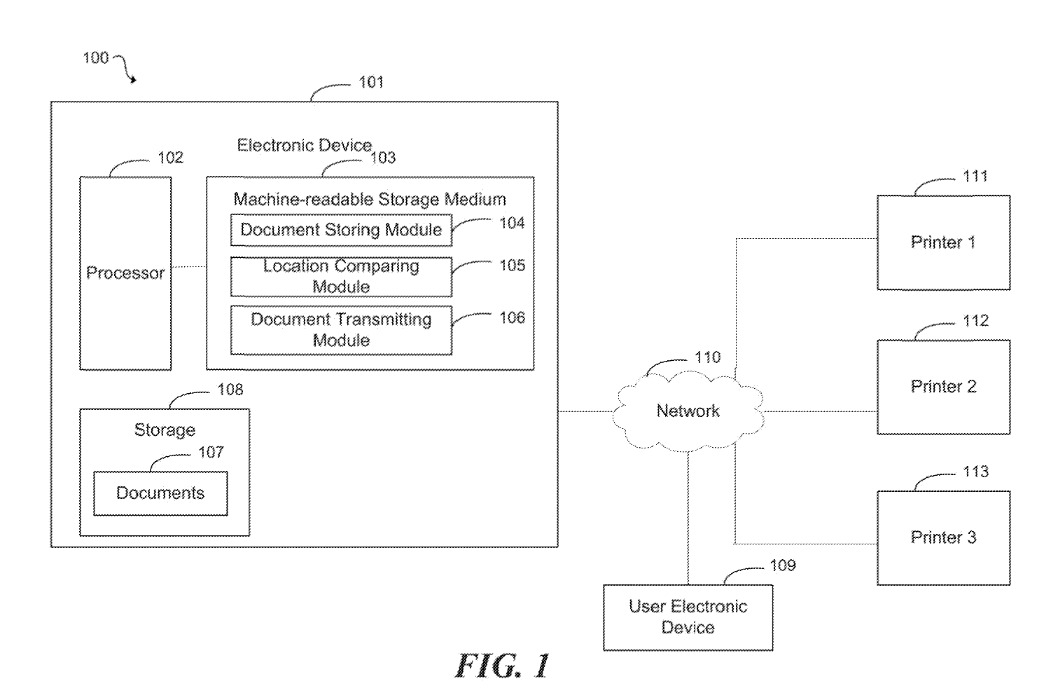

FIG. 1 is a block diagram illustrating one example of a computing system 100. The computing system 100 includes, for example, an electronic device 101, a user electronic device 109, a network 110, and printers 111, 112, and 113. The computing system 100 may allow a user to upload a document from the user electronic device 109 to the electronic device 101 which then transmits the document to at least one of the printers 111, 112, and 113 for printing. The user may select one of the printers 111, 112, or 113 for printing based on the location of the printers 111, 112, and 113, such as their location compared to a location convenient to the user for picking up the completed print job.

The network 110 may be any suitable network for communicating between the user electronic device 109 and the electronic device 101 and for communicating between the printers 111, 112, and 113 and the electronic device 101. In some implementations, the network 110 is the Internet. In some implementations, there may be more or fewer printers. The printers 111, 112, and 113 may be any suitable printers, such as printers for printing black and white documents, color documents, or photographs.

The electronic device 101 may be any suitable electronic device, such as a desktop computer, website server, or mobile computing device. The electronic device 101 may include a processor 102, a machine-readable storage medium 103, and a storage 108. The storage 108 may be any suitable storage, such as a volatile or non-volatile storage device. The storage 108 may within the electronic device 101, or the electronic device 101 may communicate with the storage 108 via a network. The storage 108 may store documents 107. In some cases, the storage 108 stores documents such that each document is associated with a user virtual printer account. For example, a user may have a virtual printer account that allows the user to send documents to the virtual printer account for printing and then associate each of the documents with an actual printer. This may allow the same user to print documents at multiple printers not associated with the user and allow other users to print at these printer as well as other printers. For example, a printing service may accept documents from virtual printer accounts for printing.

The processor 102 may be any suitable processor, such as a central processing unit (CPU), a semiconductor-based microprocessor, or any other device suitable for retrieval and execution of instructions. In one implementation, the electronic device 101 includes logic instead of or in addition to the processor 102. As an alternative or in addition to fetching, decoding, and executing instructions, the processor 102 may include one or more integrated circuits (ICs) (e.g., an application specific integrated circuit (ASIC)) or other electronic circuits that comprise a plurality of electronic components for performing the functionality described below. In one implementation, the electronic device 101 includes multiple processors. For example, one processor may perform some functionality and another processor may perform other functionality.

The machine-readable storage medium 103 may be any suitable machine readable medium, such as an electronic, magnetic, optical, or other physical storage device that stores executable instructions or other data (e.g., a hard disk drive, random access memory, flash memory, etc.). The machine-readable storage medium 103 may be, for example, a computer readable non-transitory medium. The machine-readable storage medium 103 may include instructions executable by the processor 102. For example, the machine-readable storage medium 103 may include a document storing module 104, a location comparing module 105, and a document transmitting module 106.

The document storing module 104 may include instructions executable by the processor to store a document in the storage 108. For example, the document storing module 104 may receive a document via the network 110 from the user electronic device 109. The location comparing module 105 may compare the location of printers 111, 112, and 113 to a preferred location. The preferred location may be, for example, a location determined by Global Positioning Satellite (GPS) information or by user input. The location comparing module 105 may select one of the printers 111, 112, and 113 based on the comparison of the location, such as the printer closest to the preferred location. In some cases, the location comparing module 105 includes instructions to provide information about the printer locations relative to the preferred location and receive a user selection from the provided information. The document transmitting module 107 transmits the document from the storage 108 via the network 110 to the selected printer. The selected printer may print the document once it is received. The printer, for example, could be part of a printing service for mailing the document to the user or allowing the user to pick up the printed document.

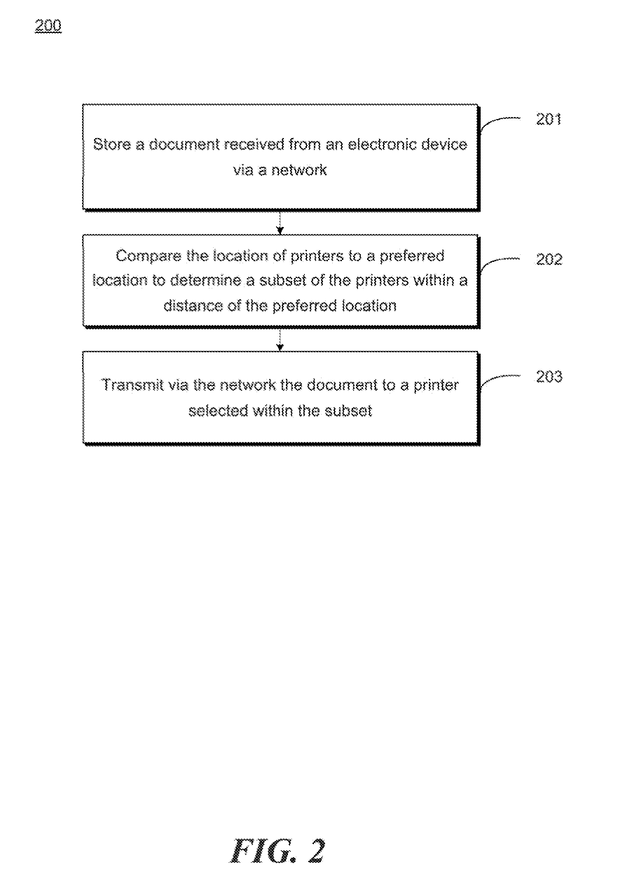

FIG. 2 is a flow chart 200 illustrating one example of a method to associate a document with a printer based on the location of the printer. In one implementation, a processor receives a document via a network. For example, a user may upload a document to be store remotely from the user's electronic device. The processor may determine printers within a distance of a preferred location and provide information about those printers. The processor may locate nearby printers or printers near a particular location so that the user may send the document to one of the printers for printing. For example, a user may want to pick up the print job at a printing service near the user's location. The processor may receive a selection of at least one of the printers and send the document for printing to the selected printer. The method may be implemented, for example, by the electronic device 101.

Beginning at 201, a processor stores a document received via a network. For example, a processor may receive a document for printing from a user's electronic device, such as a personal computer, server, or mobile computing device. The document may be received in any suitable manner. For example, a user interface may be provided for the user to upload the document or a user may send the document to an email address associated with the storage. The processor may store the document in any suitable manner. The processor may store the document in the same electronic device as the processor or in a remote storage. The processor may store additional information associated with the document, such as a user account or preferred location associated with the document. The processor may be the processor 102, and the processor may receive the document via the network 110.

In one implementation, a user establishes a virtual printer account. For example, a user may have a virtual printer instead of or in addition to owning a printer. A user may upload documents to the virtual printer account, such as through a user interface or by emailing the document to an email address associated with the virtual printer account. The processor may receive the document sent to the virtual printer account via the network and store the document for later printing. For example, the processor may transmit the document to a printer remote from the user for printing. The processor may store information about the user or virtual printer account in addition to storing the received document.

Storing the document in a storage remote from the device form which it is received may allow the document to be associated with a printer at multiple time periods, such as when the document is uploaded or when the user enters a printer services location. In some implementations, other information about the document printing may be stored, such as information about printer settings associated with the document. For example, a user may upload a document, information about a time for it to be printed, and information about a paper size for the document to be printed on. Other printer settings may include, for example, media type, duplex or simplex, monotone, draft mode, or water-marking.

In one implementation, the document may be stored for an indefinite amount of time before printing. For example, a user may upload a document for storage and a few days later decide to print the document. In some implementations, a system or user setting provides a time that a document remains in storage before being deleted. For example, a document may remain in the storage for a week, and a user may associate the document with a printer at some point during that week that the document is in storage. In some cases, a user may select to print a document immediately after uploading it to the storage.

Continuing to 202, the processor compares the location of printers to a preferred location to determine a subset of the printers within a distance of the preferred location. The processor may compare the location of printers to a preferred location in response to user input indicating that a stored document should be printed. The processor may receive information about printers. The processor may retrieve information about available printers from a storage or printer services may send information about their availability and location to the processor via a network, such as the Internet. In one implementation, the processor receives information about a preferred location. For example, the processor may receive GPS information about the current location of the electronic device sending the document for storage or may receive information about a user preferred location, such as a current position, address or, site. In some cases, the user may have a set location for each print job or may update the preferred location based on changing circumstances. A setting may indicate, for example, that printers are desired within a particular radius of a preferred location, a number of the closest printers to the preferred location, or a number or printers within the closest drive or walk time of the preferred location. The processor may compare the printer locations to the preferred location based on the settings and determine a subset of the printers. In some cases, printers may be shown on the map, and the printers within the portion of the map displayed on a user device may be selected to be the subset of printers. In some cases, the subset of printers is further refined based on other criteria, such as the availability of the printers, the cost of the print service, or the type of printer.

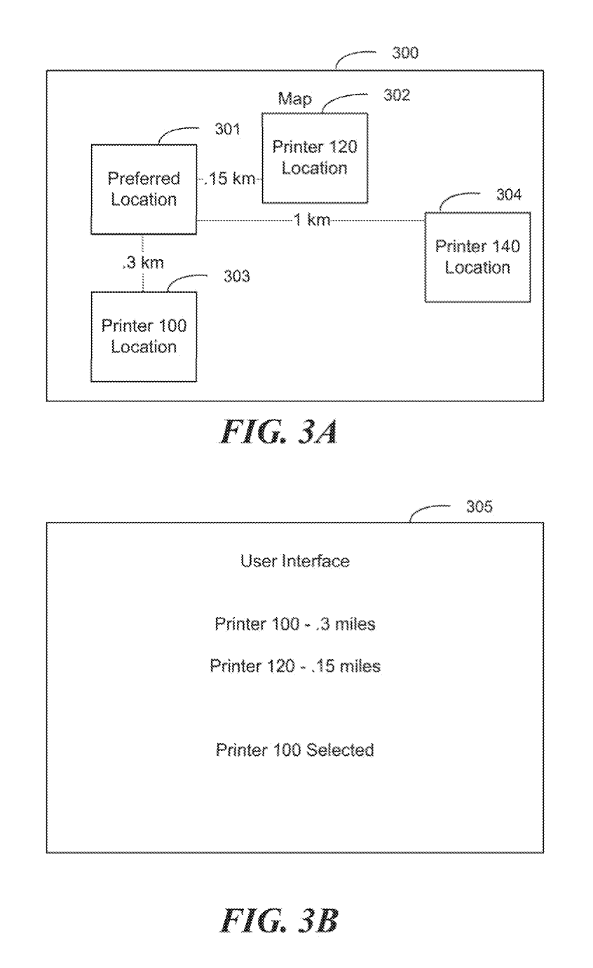

FIG. 3A is a diagram illustrating one example of comparing printer locations to a preferred location. A map 300 represents a distance between a printer 100 location 303, a printer 120 location 302, and a printer 140 location 304 and a preferred location 301. For example, the printer 100 may be 0.3 km from the preferred location 301, the printer 120 may be 0.15 km from the preferred location 301, and the printer 140 may be 1 km from the preferred location 301. In some cases, the printers 100, 120, and 140 may be associated with different printing services.

Referring back to FIG. 2 and Moving to 203, the processor transmits via the network the document to a printer selected within the subset. For example, the processor may receive a selection a printer within the subset. In some implementations, the process provides the subset of the printers to the user. For example, the processor may send information about the printers to a display device for display. A user may select one of the printers, and information about the selection may be provided to the processor. The user may select the printer, for example, based on the proximity to the user and other criteria. In some implementations, the processor automatically selects one of the processor based on stored user criteria, such as where the user indicates that the closest printer should be used in each case. In some cases, other information is provided to the user in addition to the location, such as the charge for the print job.

In one implementation, the stored document is associated with a virtual printer account, such as a printer account of an individual user. The stored document may be associated with a printer based on analysis by the processor or based on user selection. The printer may be selected based on its location. The stored document associated with the virtual printer account may then be associated with the selected printer and sent to the selected printer for printing. This may allow a user without a printer to print to a particular printer or printer service based on the location.

FIG. 3B is a diagram illustrating one example of a user interface 305 for selecting a printer. For example, a processor may determine based on a setting that printers within a 0.5 km radius of the preferred location should be selected, and the processor may determine that information about printer 100 and printer 120 should be provided to the user because of their location within the 0.5 km radius. The information may then be transmitted to and displayed on a user's electronic device. The user interface 305 shows that printer 100 is selected.

The processor may transmit via the network the document to the selected printer. For example, the processor may transmit the document via the Internet to a printer in a remote location. The printer may automatically print the document in response to receiving it or may display information about the print job and allow a user to select it for printing. In some cases, transmitting the document to the printer involves transmitting the document to an electronic device associated with the printer, such as where the printer itself does not have networking capabilities or where an electronic device performs additional processing prior to sending the print job to the printer.

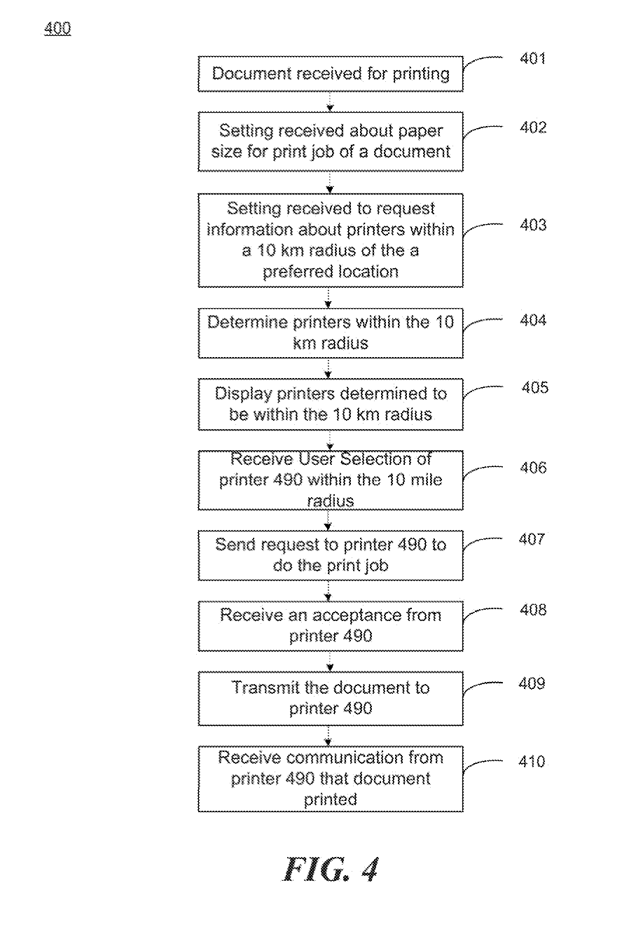

FIG. 4 is a flow chart 400 illustrating one example of associating a document with a printer based on the location of the printer. At 401, a processor receives a document for printing. The document may be received, for example, from a user electronic device where a user attaches the document to an email or uploads it through a user interface. At 402, the processor receives a setting about the paper size for the document. For example, the user may enter information from a user interface displayed on the user's electronic device that the document should be printed on A4 size paper. At 403, the processor receives information about a setting for information about printers within a 10 km radius of a preferred location. For example, the user interface may allow the user to enter a preferred location and a desired radius. At 404, the processor determines a subset of printers that are within a 10 km radius of the preferred location. At 405, the processor causes information about the subset of printers to be displayed. For example, the processor may send information about the subset of information to a user electronic device via network for display on the user electronic device.

At 406, the processor receives a selection of printer 490 within a 10 km radius of the preferred location. For example, the user may select the printer 490 from the user electronic device. At 407 the processor sends a request via a network to printer 490 to print the print job. At 408, the processor receives an acceptance via the network from printer 490. At 409, the processor transmits the document and print job settings to the printer 490. At 410, the processor receives a communication from the printer 490 that the print job is complete. The processor may cause the communication to be displayed or otherwise communicate the completion to the user. The user may choose, for example, to pick up the print job at the printer's location.

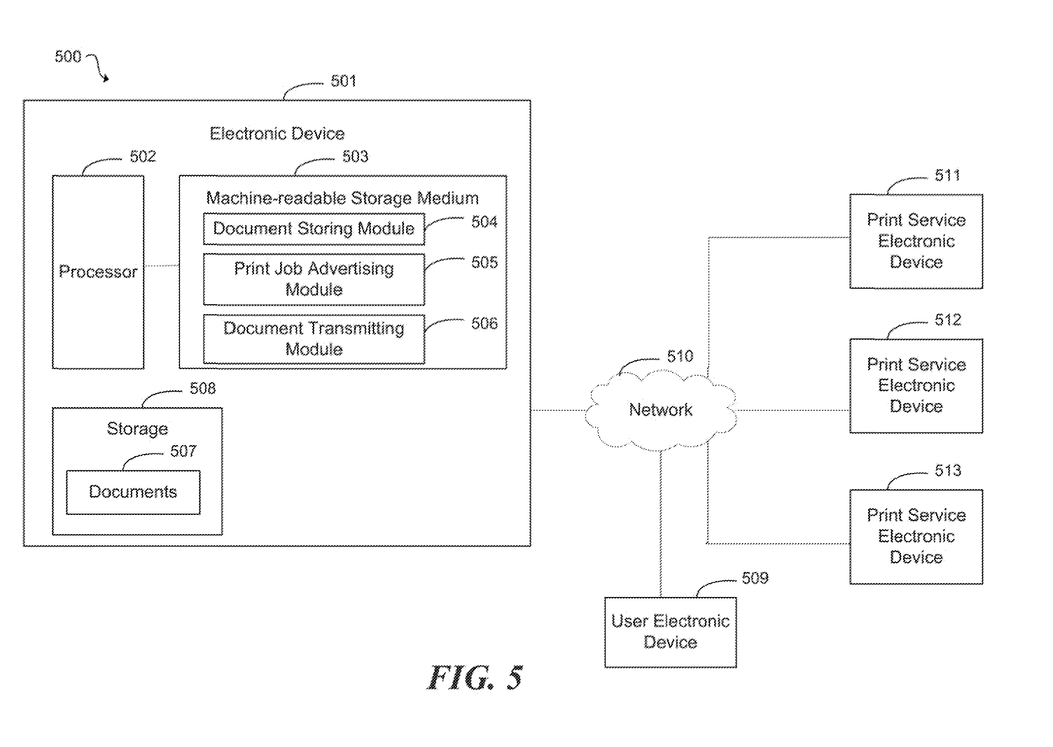

FIG. 5 is a block diagram illustrating one example of a computing system 500. The computing system 500 includes an electronic device 501, a user electronic device 509, a network 510, and printer service electronic devices 511, 512, and 513. The computing system 500 may be used, for example, to associate a stored document with a printer. For example, the processor may transmit information about an available print job for the stored document, and a printing service electronic device may request the print job. The processor may communicate the request to a user for selection or may automatically select the requesting printing service. The processor may transmit the document to the selected printing service electronic device. The user may, for example, pick up the completed print job, or the printing service may deliver or mail the completed print job to the user.

The network 510 may be used to communicate between the user electronic device 509 and the electronic device 501 and between the print service electronic devices 511, 512, and 513 and the electronic device 501. In some implementations, the network 510 is the Internet. There may be more or fewer print service electronic devices. The print service electronic devices 511, 512, and 513 may be electronic devices associated with printers or printers. In some cases, an electronic device receives a document from the electronic device 501 and forwards the document to a printer. In some cases, the electronic device 501 sends a document for printing directly to a printer.

The electronic device 501 may be any suitable electronic device, such as a server, desktop computer, or mobile computing device. The electronic device 501 may include a processor 502, a machine-readable storage medium 503, and a storage 508. The storage 508 may be any suitable storage, such as a volatile or non-volatile storage device. The storage 508 may within the electronic device 501, or the electronic device 501 may communicate with the storage 508 via a network.

The storage 508 may store documents 507. In some cases, the storage 508 stores documents such that each document is associated with a user virtual printer account. For example, a user may have a virtual printer account that allows the user to send documents to the virtual printer account for printing and then associate each of the documents with an actual printer. A printing service may request to print documents from multiple user virtual printer accounts, and multiple printing services may print documents from the same user virtual printer account.

The processor 502 may be any suitable processor, such as a central processing unit (CPU), a semiconductor-based microprocessor, or any other device suitable for retrieval and execution of instructions. In one implementation, the electronic device 501 includes logic instead of or in addition to the processor 502. As an alternative or in addition to fetching, decoding, and executing instructions, the processor 502 may include one or more integrated circuits (ICs) (e.g., an application specific integrated circuit (ASIC)) or other electronic circuits that comprise a plurality of electronic components for performing the functionality described below. In one implementation, the electronic device 501 includes multiple processors. For example, one processor may perform some functionality and another processor may perform other functionality.

The machine-readable storage medium 503 may be any suitable machine readable medium, such as an electronic, magnetic, optical, or other physical storage device that stores executable instructions or other data (e.g., a hard disk drive, random access memory, flash memory, etc.). The machine-readable storage medium 503 may be, for example, a computer readable non-transitory medium. The machine-readable storage medium 503 may include instructions executable by the processor 502. For example, the machine-readable storage medium 503 may include a document storing module 504, a print job advertising module 505, and a document transmitting module 506.

The document storing module 504 may include instructions to store a document received from the user electronic device 509 in the storage 508. The document may be associated with the user's virtual printer account such that a printer may be associated with each of the documents. The print job advertising module 505 may include instructions to advertise the availability of a print job for the stored document. For example, information about the print job may be sent to multiple electronic devices, such as the print services electronic devices 511, 512, and 513, via the network 510. In response to advertising the availability of a print job, the electronic device 501 may receive a request for the print job from one of the print services electronic devices 511, 512, or 513. The document transmitting module 506 may include instructions for transmitting the stored document to the electronic device that requested the print job to allow the requesting electronic device to print the document.

In some implementations, the electronic device 501 is combined with the electronic device 101. For example, an electronic device may provide the user an option to select a printer based on its location or allow printers to request the print job. In some implementations, printers may request a print job, and a processor may filter the requesting printers by their location compared to a preferred location.

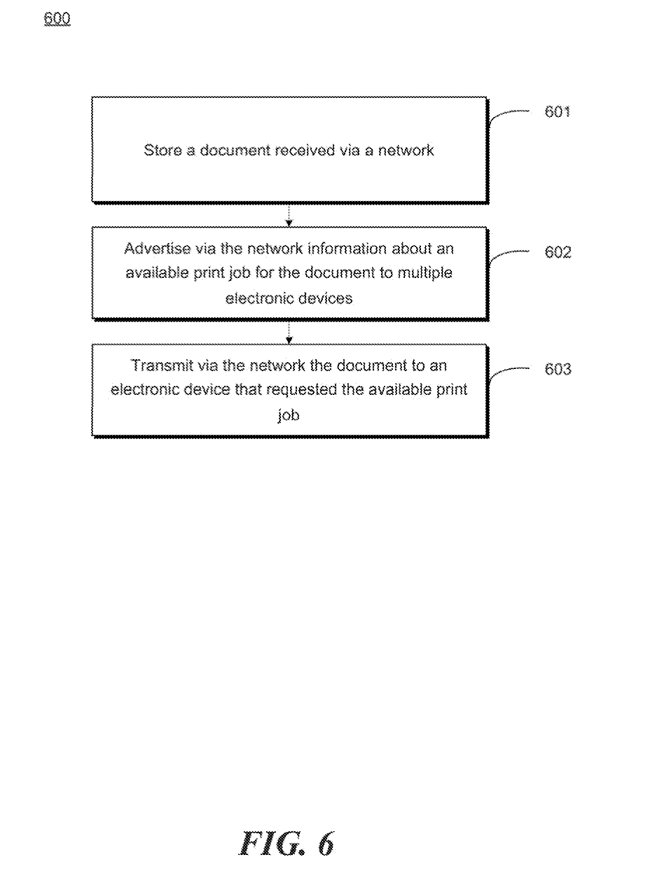

FIG. 6 is a flow chart 600 illustrating one example of a method to associate a document with a printer based on a request to print the document. A processor may receive a document for printing via a network. The processor may store the document and transmit information about the awaiting print job. An electronic device, such as an electronic device associated with a printer or printing service, may request the print job, and the processor may transmit the print job to the requesting electronic device. In some cases, printer services may request to print a document, and may then deliver or mail the printed document to a user. In one implementation, the method 600 is performed by the electronic device 501.

Beginning at 601, a processor stores a document received via a network. For example, the processor 501 may receive a document via the network 510 in the storage 508. The document may be received from a user device. In some implementations, the document may be associated with a virtual printer account. For example, a user may upload a document to a virtual printer account, and associate the document with an actual printer. The virtual printer account may allow a user's documents to be associated with different printers. As a result, a user without a printer may have documents printed by different printing services.

In one implementation, the document may be stored to be associated with a printer for printing, such as a printer of a printing service. The processor may allow the document to be stored indefinitely or for a particular amount of time. In some cases, a user may enter user input indicating that a document in the storage should be printed. The user may select to print the document immediately after uploading it to the storage or at a later time. In some cases, a user may upload a document and indicate a date in the future that the document should be printed. In response to input indicating that the document is ready to be printed, the processor may begin a processor of searching for an available printer to print the document.

Moving to 602, the processor advertises via the network information about an available print job for the document to multiple electronic devices. For example, the processor may broadcast information about the available print job to electronic devices. The information may be the document itself, a portion of the document, or information about the characteristics of the document, such as the size of the document. The processor may advertise the print job in response to user input indicating that a document should be printed.

In some implementations, the processor selects a subset of the electronic devices to advertise the print jobs to, such as electronic devices for providing print services to a particular geographical area or electronic devices with particular types of printing capabilities. In some implementations, the processor advertises information about printer settings for the document such that printer services that have capabilities of printing with the particular settings may request the print job.

Continuing to 603, the processor transmits via the network the document to one of the electronic devices that requested the available print job. For example, the processor may receive requests for the print job, such as printing services offering to print the document for a fee. The processor may allow a user to select one of the requesting print services or may automatically select one of the requesting print services. For example, a particular print service may be automatically selected based on its location or price. In one implementation, the processor starts a bidding process with print service providers. In some cases, the bidding process may be performed for a subset of printer service providers, such as those within a particular location. The processor may compare information about a service level objective associated with a print job or a user initiating a print job to information about each print service provider. The processor may receive information from the print service providers, such as information about quality and price, and may select one of the print service providers based on the received information. For example, the lowest cost provider meeting a quality standard may be selected for the print job.

In one implementation, the processor stores a document associated with a virtual printer account of a user. The processor may associate the document with a printing service based on a request to print the document. The processor may in some implementations notify the user of the printing service selected. The process may then transmit the document to the printing service. This may allow a virtual printer account owner to upload a document for printing without knowledge of available printers because the processor may receive requests from available printers.

In some implementations, the processor may cause information about print service providers requesting the print job to be displayed on a user interface for a user to select one of the print services. Information about the printer services providers may also be shown to a user, such as information about price. The processor may transmit the document to the selected electronic device via the network. The selected electronic device may be, for example, a printer, or an electronic device for sending the document to a printer.

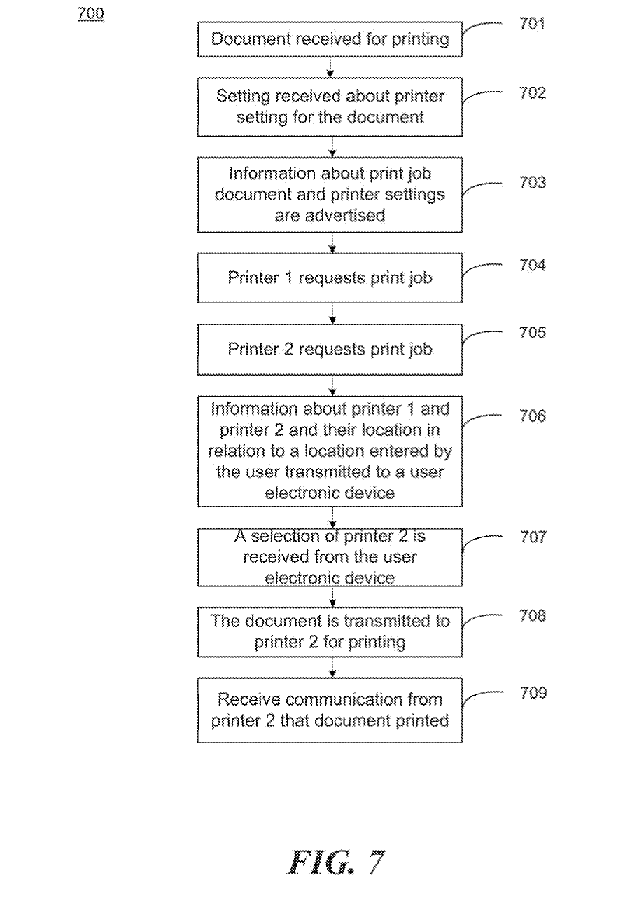

FIG. 7 is a flow chart 700 illustrating one example of associating a document with a printer based on a request to print the document. At 701, a processor receives a document for printing. For example, the processor may retrieve the document from a storage. At 702 the processor receives information about printer settings for the document. For example, a user may input information in a user interface that the document should be printed on letterhead size paper, and the paper size information may be transmitted from the user's electronic device to the processor via a network. At 703, information about the print job is advertised to other electronic devices. For example, the processor may send information to known electronic devices about the document, such as the size of the document and the selected paper size. At 704, printer 1 requests the print job, such as by transmitting a response to the processor via a network. At 705, printer 2 requests the print job. At 706, the processor compares the locations of printer 1 and printer 2 to a user's preferred location and transmits the information to a user's electronic device for display. At 707, the user selects printer 2 from a user interface displayed on the user electronic device, and information about the selection of printer 2 is transmitted to the processor. At 708, the processor transmits the document to printer 2 for printing. At 709, the processor receives a communication from printer 2 that the document printed. The processor may transmit a message to the user to indicate that the print job is ready. In some cases, the print job may be delivered to or mailed to the user.

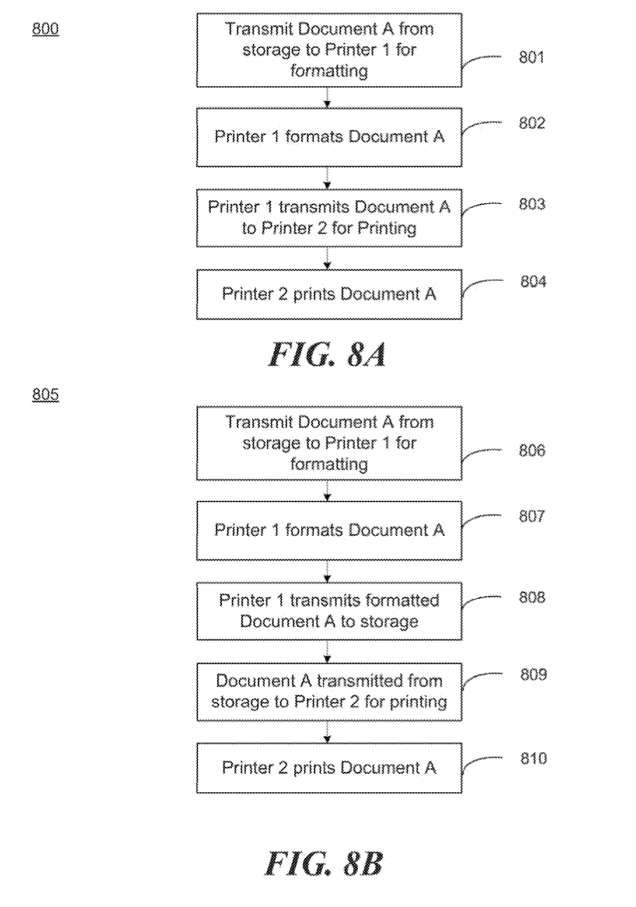

FIGS. 8A and 88 are flow charts 800 and 805 illustrating examples of methods to transmit a document to a first printer for formatting and to a second printer for printing. At 801, a processor, such as the processor 501, transmits document A from a remote storage to Printer 1 for formatting. For example, the processor may receive a request from a printer to perform formatting or may have a list of formatting services available from printers in a storage accessible to the processor. At 802, printer 1 receives Document A and performs the processing requested by the processor. The formatting may include, for example, the document may be changed to a wide format. In one implementation, the processor advertises for a particular type of print formatting job availability and receives requests from printers. At 803, printer 1 transmits formatted Document A to printer 2 for printing. For example, the processor may send instructions to printer 1 about a printer to forward the formatted document to for printing. At 804, printer 2 receives formatted document A for printing and may print the document.

FIG. 8B illustrates an example method to transmit a document to a first printer for formatting and a second printer for printing where a central electronic device controls the transmission of the document. At 806, the processor transmits Document A to printer 1 for formatting. At 806, printer 1 formats Document A, such as according to instructions from the processor. At 808, printer 1 transmits the formatted Document A to a storage or to the processor for storing the formatted document. At 809, the processor transmits Document A to printer 2 for printing, and at 810, printer 2 prints Document A.

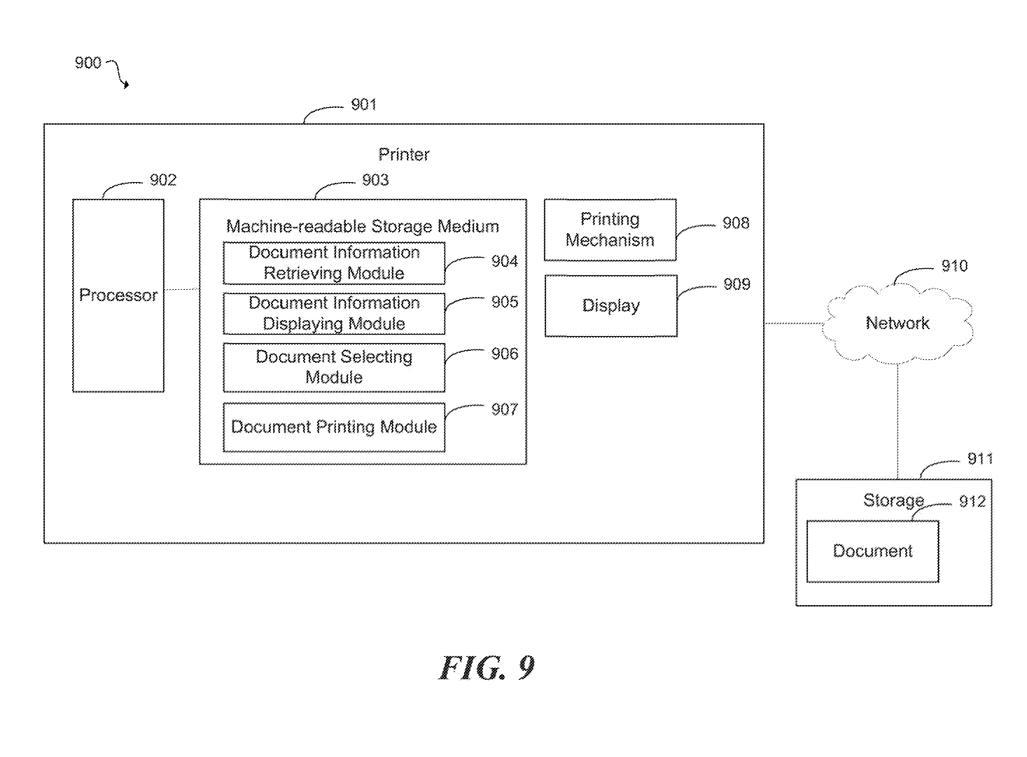

FIG. 9 is a block diagram illustrating one example of a computing system 900. The computing system 900 may be used to allow a user to select a document received for printing before the printing process begins. Implementations that allow a document in a storage to be associated with a remote printer may cause ink loss where a document is automatically printed on a printer without the printer owner's control. In one implementation, a printer displays information about documents ready for print and allows documents to be selected prior to printing.

The computing system 900 includes a printer 901, a network 910, and a storage 912. The network 910 may be any suitable network for communicating between the printer 901 and the storage 912. The network 901 may be, for example, the Internet. The storage 912 may be any suitable storage. The storage may be, for example, the storage 108 or 508. The storage 912 may include a document 912. The document 912 may be received from a user electronic device. In some cases the document 912 may be associated with a printer. For example, a user may select a particular printer for printing the document 912.

The printer 901 may be any suitable printer. The printer 901 may have networking capabilities or the printer 901 may include a printer coupled to a separate electronic device with networking capabilities. The printer 901 may include a processor 902, a machine-readable storage medium 903, a printing mechanism 908, and a display 909. The printing mechanism 908 may be used to print a document. For example, the printing mechanism 908 may receive information from the processor 902 about a document to print. The display 909 may be a display device within the printer 901 or coupled to the printer 901. The display 909 may display information about documents to be printed, such as information about the origin of a document or information about printer settings for the document.

The processor 902 may be any suitable processor, such as a central processing unit (CPU), a semiconductor-based microprocessor, or any other device suitable for retrieval and execution of instructions. In one implementation, the printer 901 includes logic instead of or in addition to the processor 902. As an alternative or in addition to fetching, decoding, and executing instructions, the processor 102 may include one or more integrated circuits (ICs) (e.g., an application specific integrated circuit (ASIC)) or other electronic circuits that comprise a plurality of electronic components for performing the functionality described below. In one implementation, the printer 901 includes multiple processors. For example, one processor may perform some functionality and another processor may perform other functionality.

The machine-readable storage medium 903 may be any suitable machine readable medium, such as an electronic, magnetic, optical, or other physical storage device that stores executable instructions or other data (e.g., a hard disk drive, random access memory, flash memory, etc.). The machine-readable storage medium 903 may be, for example, a computer readable non-transitory medium. The machine-readable storage medium 903 may include instructions executable by the processor 902.

The machine-readable storage medium 903 may include, for example, a document information retrieving module 904, a document information displaying module 905, a document selecting module 906, and a document printing module 907. The document information retrieving module 904 may include instructions executable by the processor 902 for retrieving a document, such as the document 912, within the storage 911. For example, the storage 911 may include documents associated with different printers, and the document information retrieving module 904 may include instructions to retrieve information about documents associated with it. The document information may include, for example, a user or user virtual printer account associated with the document or the length of the document. In some implementations, the actual document is retrieved.

The document information displaying module 905 may include instructions for displaying information about the retrieved document on the display 909. For example, information about the document may be displayed for a user to view. In some cases, the document or a portion of the document may be displayed on the display 909. The document selecting module 906 may include instructions for creating a user interface to allow a user to select whether to print a document. For example, a list of documents may be displayed on the display 909, and a user may select one of them for printing. In some cases, one document is shown, and a user accepts or denies the request for printing. The document printing module 907 may include instructions to print selected documents using the printing mechanism 908. In some implementations, the printer 901 prints documents received from the electronic device 101 or 501. For example, the printer 901 may be selected for printing based on its location, or the printer 901 may request the print job for the document.

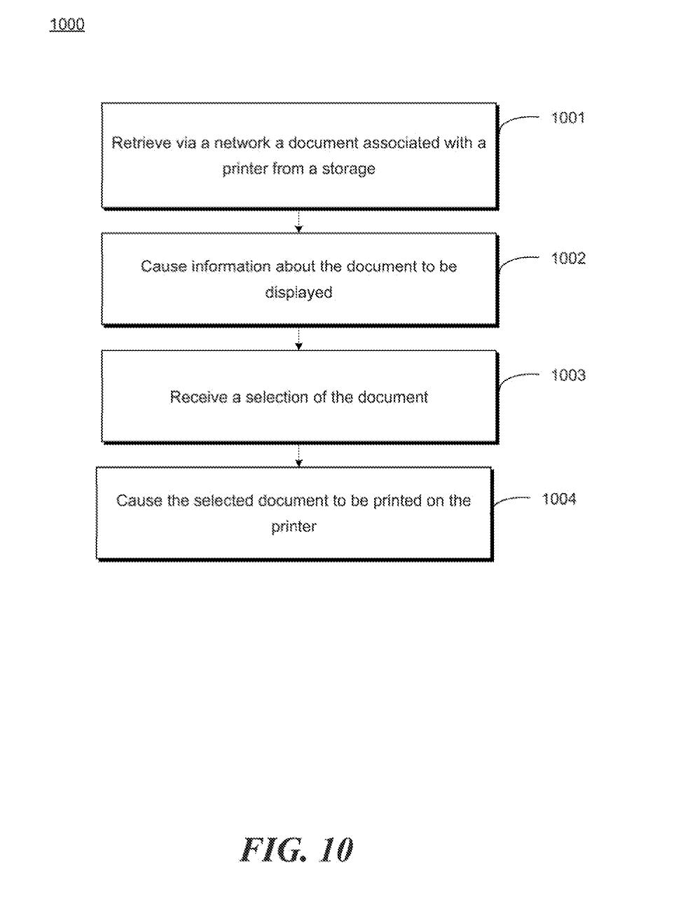

FIG. 10 is a flow chart 1000 illustrating one example of a method to select a document for printing. A printer may allow a user to select whether to print a received document before printing. For example, the method may be used to prevent spam and ink loss where a user may upload a document at one electronic device to a storage and associate the document with a remote printer for printing. In one implementation, a user may create a customized application for retrieving and displaying print documents associated with the user's virtual printer account on a printer. For example, criteria for documents that are displayed and how they are displayed may be customized for a particular user. In some cases, the customized application may be accessed from multiple printers, such as through the Internet. The customization may be an extension to an application for displaying documents on a display associated with a printer and receiving a selection of a document for printing. The method may be implemented, for example, by the printer 901.

Beginning at 1001, a processor retrieves via a network a document associated with a printer from a storage. The processor may be, for example, the processor 902 retrieving a document from the storage 911 via the network 910. The printer may, for example, request documents from the storage that are associated with the printer. The documents may be associated with user virtual printer accounts. For example, a user may have a virtual printer account for storing documents remotely from a user where the user may associate an actual printer with each of the documents within the virtual printer account. In one implementation, a user uploads the document to a storage using a virtual printer application, and the printer may have an application to interface with the storage storing the document. The processor may retrieve documents where the documents are each associated with a virtual printer account of a different user. For example, users may upload documents to their virtual printer accounts where the users do not have access to a printer. The documents may be sent to the same printer for printing, such as the same printing service, even though the users of the virtual printer accounts are not associated with one another.

In one implementation, a user may interact with the process using a user interface displayed on a display associated with the printer. The user may access his virtual printer account from the printer. At that point, the processor may retrieve documents associated with the particular virtual printer account. These documents may later be displayed to allow a user to select whether to print some of the documents associated with the virtual printer account on the printer. Moving to 1002, the processor causes information about the document to be displayed. For example, the processor may cause the document or a portion of the document to be displayed on a display associated with a printer. The information about the document may be information about a user or virtual printer account associated with the document. The information may include information about the size of the document or the amount of estimated ink to be used to print the document. Other printer settings received may include, for example, media type, duplex or simplex, monotone, draft mode, or water-marking. The display may be, for example, a monitor connected the printer or a display embedded within the printer housing.

Proceeding to 1003, the processor receives a selection of the document. For example, a user may select a document to begin printing or select the document to print at a later time. The user may select a document by providing touch input to the display, using a peripheral input device, or other method. In some cases, some control is executed automatically. For example, a user may previously indicate that a document from a particular user account should not print, and information about future documents from the account may no longer be displayed for user selection.

Continuing to 1004, the processor causes the selected document to be printed on the printer. For example, the printer may begin printing a selected document. In some cases, the printer receives information about printer settings associated with a document. For example, a user may upload a document for printing to a remote storage and indicate that printer settings for the document are A4 paper size. The information about the printer settings may be transmitted to the printer from the storage via the network, and the printer may print the document according to the received settings.

1. An electronic device 101 to associate a document with a printer, comprising:
a processor 102 to:
store a document received via a network;
compare the location of printers to a preferred location to determine a subset of the printers within a distance of the preferred location;
transmit via the network the document to a printer selected within the subset.

2. The electronic device of claim 1, wherein the processor 102 selects at least one of the printers in the subset based on a criteria comprising at least one of:
the availability of the printer; and
the distance of the printer to the preferred location compared to the distance of other printers in the subset to the preferred location.

3. The electronic device of claim 1, wherein the processor 102 further sends a request for printing to the selected printer and transmitting the document to the selected printer when the request is accepted.

4. The electronic device of claim 1, wherein the processor 102 further:
causes information about the printers within the subset to be displayed; and
receives a selection of at least one of the printers.

5. The electronic device of claim 4, wherein determining a subset of printers comprises determining which of the list of printers are within a proximity of the preferred location.

6. The electronic device of claim 1, wherein the processor 102 further:
receives printer settings associated with the document; and
transmits the printer settings to the selected printer.

7. The electronic device of claim 1, wherein the document is associated with a user virtual printer account and wherein a second document associated with the user virtual printer account is transmitted via the network to a different printer than the selected printer.

8. A method to associate a document with a printer, comprising:
storing, by a processor 502, a document received via a network;
advertising, by a processor 502, via the network information about an available print job for the document to multiple electronic devices; and
transmitting, by a processor 502, via the network the document to an electronic device that requested the available print job.

9. The method of claim 8, further comprising selecting an electronic device where multiple electronic devices requested the available print job.

10. The method of claim 9, further comprising determining the location of the multiple electronic devices that requested the available print job compared to a preferred location.

11. The method of claim 8, further comprising:
advertising via the network information about a formatting job for the document; and
transmitting the document to a second electronic device that requested the formatting job.

12. The method of claim 8, further comprising:
associating the document with a user virtual printer account; and
transmitting a second document associated with the user virtual printer account to a second electronic device that requested an available print job for the second document.

13. A computer readable non-transitory storage medium 903 comprising instructions executable by a processor 902 to:
retrieve via a network a document associated with a printer from a storage;
cause information about the document to be displayed on the printer;
receive a selection of the document; and
cause the selected document to be printed on the printer.

14. The computer readable non-transitory storage medium 903 of claim 13, further comprising instructions to retrieve via the network information about printer settings associated with the document and wherein instructions to cause the document to be printed comprise instructions to cause the document to be printed based on the retrieved printer settings associated with the document.

15. The computer readable non-transitory storage medium 903 of claim 13, wherein the document is associated with a user virtual printer account.
